(19) United States
(12) Patent Application Publication
(10) Pub. No.: US 2016/0377271 A1
(43) Pub. Date: Dec. 29, 2016

(54) DEVICE WITH LIGHTING, LOCATION, AND COMMUNICATION SYSTEMS

(71) Applicant: LightUpToys.com LLC, Sellersburg, IN (US)

(72) Inventors: Joshua Kelly, Sellersburg, IN (US); Max Armendariz Lalama, Georgetown, IN (US); Christopher Kelly, New Albany, IN (US); Macaulay Bruton, Jeffersonville, IN (US)

(21) Appl. No.: 14/750,896

(22) Filed: Jun. 25, 2015

(51) Int. Cl. F21V 23/00; F21S 9/02; F21V 8/00; F21V 23/04; H05B 37/02; H05B 33/08; H05B 33/12; F21V 23/02; F21S 4/10

(52) U.S. Cl. CPC F21V 23/003; F21V 23/02; F21S 9/02; G02B 6/0076; G02B 6/0036; F21S 4/10; H05B 37/0272; H05B 33/0854; H05B 33/12; H05B 37/0227; H05B 37/0236; F21V 23/0471; H05B 37/0281; H05B 37/029; F21W 2121/00

(57) ABSTRACT

The present invention relates to the field of entertainment devices. More particularly, the present invention relates to the field of entertainment devices that utilize electronics, and lighting, location, and communication system(s). At least one current embodiment of the present invention is an animated device with lighting and flip style animations.

### CROSS-REFERENCE TO RELATED APPLICATIONS

This application claims the benefit of U.S. Provisional Application No. 62/016,787, filed Jun. 25, 2014, U.S. Provisional Application No. 62/082,164, filed Nov. 20, 2014.

### BACKGROUND OF THE INVENTION

The present invention relates to the field of entertainment devices. More particularly, the present invention relates to the field of entertainment devices that utilize electronics, and lighting, location, and communication system(s). At least one current embodiment of the present invention is an animated device with lighting and flip style animations.

### SUMMARY OF THE INVENTION

The present invention may comprise of at least one of the following: at least one light-emitting diode assembly, wherein said at least one light-emitting diode assembly may be comprised of at least one of at least one light-emitting diode, and/or at least one resistor; at least one electroluminescence assembly, wherein said at least one electroluminescence assembly may be comprised of at least one of at least one electroluminescent wire, sheet, panel, or tape, and/or at least one inverter; at least one power source, which can be a batter and can be operably connected to at least one of the at least one light-emitting diode assembly or the at least one electroluminescence assembly, wherein at least one of the at least one light-emitting diode assembly and/or said at least one electroluminescence assembly can be connected to said at least one power source whereby a circuit can be formed; at least one power source compartment, wherein said at least one power source compartment can house the at least one power source; at least one transparent and/or translucent material, wherein said at least one transparent and/or translucent material can be capable of transmitting and/or radiating light, can be made of at least one of glass, plexiglass, acrylic, and/or resin, and/or can have at least one of images, text, logos, slogans, characters, other visual materials, and/or other visual content that are at least one of etched, sandblasted, molded, engraved, imprinted, ingrained, cut, impressed and/or outlined into or on said at least one transparent and/or translucent material; circuitry associated with and/or used to control at least one of the at least one light-emitting diode assembly, the at least one electroluminescence assembly, and/or the at least one power source, wherein said circuitry, when associated with and/or used to control at least one of the at least one light-emitting diode assembly and/or the at least one electroluminescence assembly, can provide at least one of the following light pattern types: random, regular, controlled sequence and/or pattern, custom sequence and/or pattern, and/or sequence and/or pattern incorporating at least one constant timing, variable timing and/or dimming function; at least one switch or other circuit activating and/or deactivating device; and/or at least one housing unit.

The at least one switch or other circuit activating and/or deactivating device can an on/off switch that activates and/or deactivates the circuitry associated with and/or used to control at least one of the at least one light-emitting diode assembly, the at least one electroluminescence assembly, and/or the at least one power source.

The at least one light-emitting diode assembly and/or the at least one electroluminescence assembly can attach or otherwise connect to the at least one transparent and/or translucent material, and/or can direct light into and/or through the at least one transparent and/or translucent material.

The at least one light-emitting diode of the at least one light-emitting diode assembly, if present, can be at least two light-emitting diodes. The at least one electroluminescent wire, sheet, panel, or tape of the at least one electroluminescence assembly, if present, can be at least two electroluminescent wires, sheets, panels, or tape. The at least one transparent and/or translucent material can be at least two transparent and/or translucent materials. Said at least two transparent and/or translucent materials are connected, combined, or otherwise attached to one another to form a combined piece of transparent and/or translucent material, wherein each of the at least two transparent and/or translucent materials can be a separate layer of said combined piece of transparent and/or translucent material. Each separate layer of the combined piece of transparent and/or translucent material can be connected or otherwise attached to at least one of at least one of the at least two light-emitting diodes of the at least one light-emitting diode assembly, and/or at least one of the at least two electroluminescent wires, sheets, panels, or tape of the electroluminescence assembly. At least one of at least one of the at least two light-emitting diodes, and/or at least one of the at least two electroluminescent wires, sheets, panels, or tape may be used only in connection with a designated separate layer of the combined piece of transparent and/or translucent material, and may not not shared or used by any other separate layer of the combined piece of transparent and/or translucent material. At least one of each of the at least two light-emitting diodes, and/or each of the at least two electroluminescent wires, sheets, panels, or tape can provide light into and/or through such light-emitting diode or electroluminescent wire, sheet, panel, or tape's designated separate layer of the combined piece of transparent and/or translucent material in a sequence. The light from at least one of each of the at least two light-emitting diodes, and/or each of the at least two electroluminescent wires, sheets, panels, or tape can be provided in sequence, and not in parallel, and such light sequence can create the appearance of animation of images, text, logos, slogans, characters or other visual materials and content that are at least one of etched, sandblasted, molded, engraved, imprinted, ingrained, cut, impressed and/or outlined into or on such layer of the one piece of transparent and/or translucent material as the sequence progresses.

The present invention can can further comprise an illuminated accessory that operates independently from or in conjunction with the present invention. Said illuminated accessory can comprise of at least one of the following: at least one light string system; at least one internal light string system; at least one illuminated accessory electroluminescence assembly, wherein said at least one illuminated accessory electroluminescence assembly can be comprised of at least one of at least one electroluminescent wire, sheet, panel, or tape, and/or at least one inverter; at least one illuminated accessory power source, wherein said at at least one illuminated accessory power source can comprise of at least one of at least one battery, and/or at least one printed circuit board; at least one pliable material, wherein said at least one pliable material can be made of pliable material, such as cloth, fabric, wire, rubber, metal, elastic, spandex, twine, rope, and/or cord; and/or at least one translucent material, wherein said at least one translucent material can be at least one of flexible and/or inflexible. The light string system, if present, and/or said internal light string system, if present, can be comprised of at least one lighting and/or lamp system tied together with at least one conductive wire, wherein each lighting and/or lamp system consists of at least one of at least one light assembly, at least one bulb assembly, and/or at least one socket assembly. At least one of the at least one light string system, the at least one internal light string system, and/or the illuminated accessory electroluminescence assembly can be connected to at least one of the at least one light-emitting diode assembly, the at least one electroluminescence assembly, the at least one power source, the circuitry associated with and/or used to control at least one of the at least one light-emitting diode assembly, the at least one electroluminescence assembly, and/or the at least one power source, and/or the at least one illuminated accessory power source. The circuitry associated with and/or used to control at least one of the at least one light-emitting diode assembly, the at least one electroluminescence assembly, and/or the at least one power source of the device can additionally control at least one of the at least one light string system, the at least one internal light string system, and/or the at least one electroluminescent panel, and can cause at least one of the following light pattern types: random, regular, controlled sequence and/or pattern, custom sequence and/or pattern, sequence and/or pattern incorporating at least one constant timing, variable timing and/or dimming function. The at least one light string system and/or at least one internal light string system, if present, can have at least two LEDs directly connected to the same circuitry and/or wiring in a sequential manner without the need or use of any light string covers.

The present invention can further comprise a tracking and/or communication system. Said tracking and/or communication system can comprise at least one of the following: a tracking apparatus; a communication receiver device; at least one of a control device and/or a communication transmitter device and/or a communication transmitter/receiver device; at least one power source, wherein said at least power source can be comprised of at least one of: at least one battery, at least one battery compartment, and/or at least one battery compartment door; a controlling, executing and/or operating software application can be utilized to control or operate at least one control device and/or communication transmitter device and/or communication receiver device and/or communication transmitter/receiver device; at least one LED light; at least one switch and/or at least one sensor and/or at least one connector; circuitry to control at least one LED light; and/or a transparent and/or translucent flexible exterior material permitting the transmission of light. At least one of the at least one tracking apparatus, and/or at least one control device, and/or at least one communication receiver device, and/or the at least one communication transmitter device, and/or the at least one communication transmitter/receiver device, if present, can receive and/or transmit at least one of the following signals: GPS, Wi-Fi, radio wave, Bluetooth, RFID, radio waves, sonar, sonic, audio, vibration, light, sound, and/or infrared. At least one communication receiver device and/or at least one communication transmitter device and/or at least one communication transmitter/receiver device, if present, can be attached or connected to, and/or located partially or wholly within or inside the tracking apparatus and/or can be the tracking apparatus. At least one communication receiver device and/or at least one communication transmitter device and/or at least one communication transmitter/receiver device can be located within or attached to at least one control device. The at least one control device can be at least one of at least one remote control, computer, input device, output device, tablet, smart phone, smart device, sound device, public address (PA) system, audio system, amplifier system, speakers, and/or a stationary, handheld, and/or mobile device. The at least one remote control, if present, can further comprise at least one button or other signal controller that, when depressed or initiated or activated, can send or receive at least one signal from or to the at least one communication transmitter device or communication transmitter/receiver device located in the at least one remote control to the at least one communication receiver device or communication transmitter/receiver device located in the at least one tracking apparatus. The at least one controlling, executing and/or operating software application, when activated and/or instructed to, can send a signal from the at least one communication transmitter device or communication transmitter/receiver device located in the control device to the tracking apparatus and/or at least one communication receiver device and/or communication transmitter/receiver device located in/on the at least one tracking apparatus. The at least one tracking apparatus can be placed, embedded within, or built inside said at least one housing unit of the device with lighting, location, and communication systems, or removably attached via an attaching mechanism to said at least one housing unit. The at least one tracking apparatus can be attached or otherwise connected to the at least one switch or other circuit activating and/or deactivating device and/or the circuitry associated with and/or used to control the at least one light-emitting diode assembly, the at least one electroluminescence assembly, and/or the at least one power source whereby at least one tracking apparatus and/or control device to control the patterns of lighting produced by said light-emitting diode assembly and/or the light string system and/or internal light string system. The at least one tracking apparatus and/or control device can further comprise at least one of the following: a speaker, an audio or sound device, and/or a vibrating device. The at least one control device can send at least one signal from the at least one communication transmitter device or communication transmitter/receiver device located in the control device to the at least one communication receiver device or communication transmitter/receiver device located in/on the tracking apparatus that results in the at least one speaker and/or audio device, if present, emitting a sound, the at least one light-emitting diode assembly and/or the electroluminescence assembly, if present, illuminating, the vibrating device, if present, vibrating, and/or the at least one communication receiver device or communication transmitter/receiver device transmitting and/or sending at least one signal to the at least one communication transmitter device or communication transmitter/receiver device. Said at least one switch and/or at least one sensor and/or at least one connector can be sensed by and/or connected to electronics. Said at least one switch and/or at least one sensor can be at least one of motion and/or acceleration and/or impact activated. Motion and/or said at least one sensor output can cause electronics to remain active for a minimum period of time. If motion and/or said at least one sensor output has not caused activation for said minimum period of time, the electronics can enter a low current sleep mode to conserve battery energy. Motion and/or said at least one sensor output can initiate wake up of electronics from a low current mode. The at least one sensor can sense acoustic energy and/or audio from the environment and convert said acoustic energy and/or audio into a signal. The device can further comprise electronics able to control the lighting of said at least one LED light in at least one lighting sequence. Said at least one switch and/or at least one sensor activation can initiate at least one lighting sequence. The at least one lighting sequence can at least one of the following: repetitive, and/or random. The at least one lighting sequence can incorporate at least one of the following: constant timing, variable timing, and/or a dimming function. Said signal can be resolved into frequency and/or amplitude and/or a combination thereof. Said at least one connector can be a connector and/or jack for connecting to an audio, video and/or other content source and/or power. Said frequency and/or amplitude and/or a combination thereof can control or affect the pattern and or intensity of LED lighting.

The present invention, including the illuminated accessory can be at least one of the following: worn by a user, attached to other objects, held in a user's hand, put on display, or formed in any shape, including the shape of glasses, a toy star, toy planet, crystal, sphere, rod, staff, blade, disk, device, wand, multi-sided, polyhedron shape, geometric shape, triangle shape, quadrilateral shape, pentagon shape, hexagon shaped, septagon shaped, octagon shaped, polygon of any number of sides, a commonly recognizable toy(s), consumer product, and/or shape(s) including but not limited to: a character, caricature, celebrity or person's shape or image in whole or part, logo, symbol, rocket, airplane, car, animal, bug, plant, rock, rock formation, body part(s), machine, vehicle, boat, alien, wand, sword, knife, gun, pistol, boat, submarine, toy sword, toy vehicle, toy gun, toy, toy shield, toy wand, doll, toy figure, figurine, toy figurine, action figure, toy action figure, remote controlled vehicle, remote controlled airplane, remote control toy, remote controlled helicopter, remote controlled rocket, and/or remote controlled quad copter, hand held toy(s), construction toy(s), toy block(s), pet(s), accessories, apparel, footwear, hair accessories, jewelry, fashion accessories, sports balls and equipment, bike accessories, bike spokes, costumes, headwear, skateboard accessories, wheels, wheel accessories, vehicle accessories, skateboard wheels, snowboard, yo-yo, spinning top, fan, Frisbee, nightstand, nightlight, electronic device, radio, clock radio, mobile phone accessory, and/or desktop device.

### BRIEF DESCRIPTION OF THE SEVERAL VIEWS OF THE DRAWING

FIG. 1 shows one embodiment of the present invention with an illuminated pendant, which has the image of snowflake etched within said pendant or engraved into said pendant's surface, connected to an illuminated accessory.

FIG. 2 shows one embodiment of the present invention with an illuminated pendant, which has the text “MERRY CHRISTMAS” etched within said pendant or engraved into said pendant's surface, connected to an illuminated accessory.

FIG. 3 shows one embodiment of the present invention with an illuminated pendant, which has the text “MERRY CHRISTMAS” and the image of a snowflake etched within said pendant and/or engraved into said pendant's surface, connected to an illuminated accessory, and shows the transition of the LED lights bringing the “MERRY CHRISTMAS” text into focus and bringing the snowflake image out of focus.

FIG. 4 is a diagram of a side view of one embodiment of the present invention with a pendant with two layers, two lights, and a housing unit.

FIG. 5 is a view of the front and side of one embodiment of the present invention with a pendant with three layers and a housing unit.

FIG. 6 is a view of the back and side of one embodiment of the present invention with a pendant with three layers and a housing unit.

FIG. 7 is a view of the back of one embodiment of the present invention.

FIG. 8 is a view of the front of one embodiment of the present invention.

FIG. 9 is a view of inside the housing unit in one embodiment of the present invention.

FIG. 10 is a front view of one embodiment of the present invention showing the front surface of the present invention with the invention attached or otherwise connected to an illuminated accessory and a tracking apparatus.

### DETAILED DESCRIPTION OF THE INVENTION

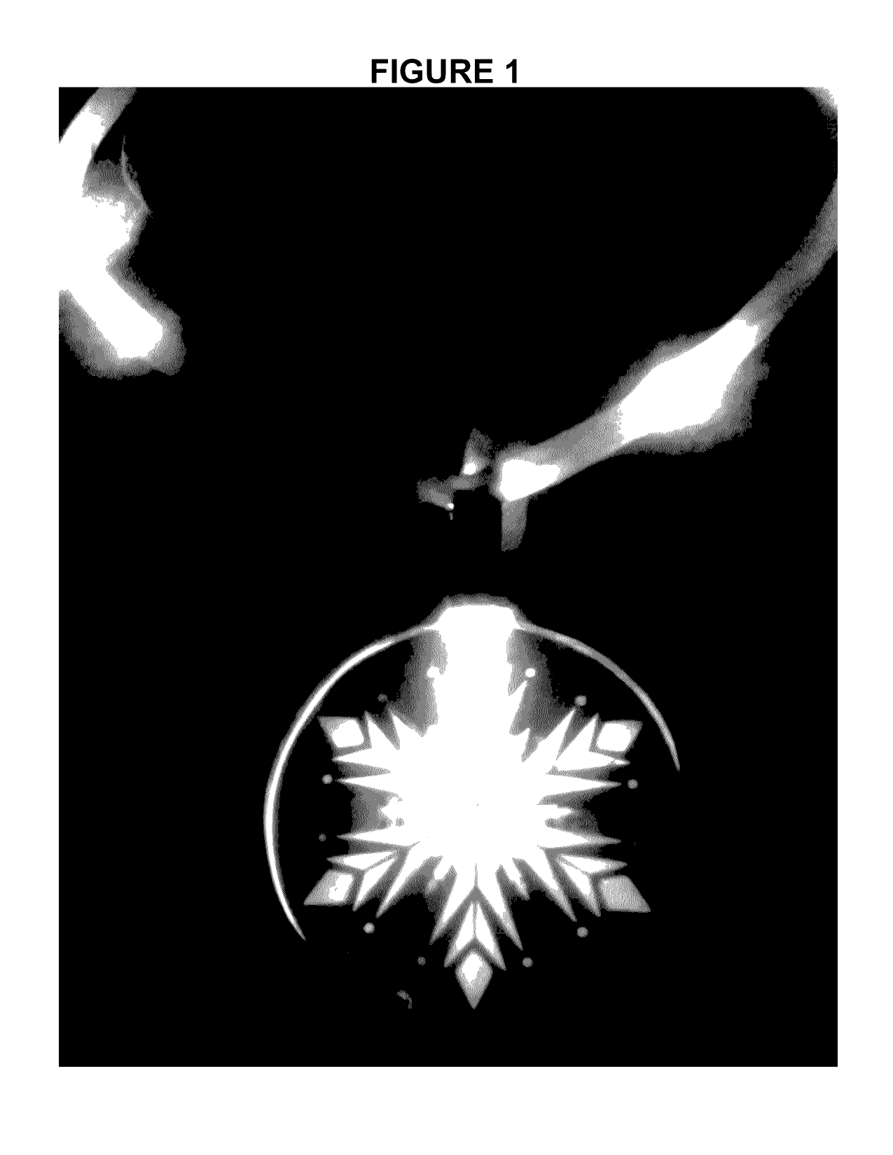

FIG. 1 shows one embodiment of the present invention with an illuminated pendant, which has the image of snowflake etched within said pendant or engraved into said pendant's surface, connected to an illuminated accessory. In this embodiment, the LED attached to the layer of the pendant that has the image of the snowflake sandblasted into its surface is illuminated and illuminates the image of the snowflake within such layer of the pendant, and the illuminated accessory is a neckpiece.

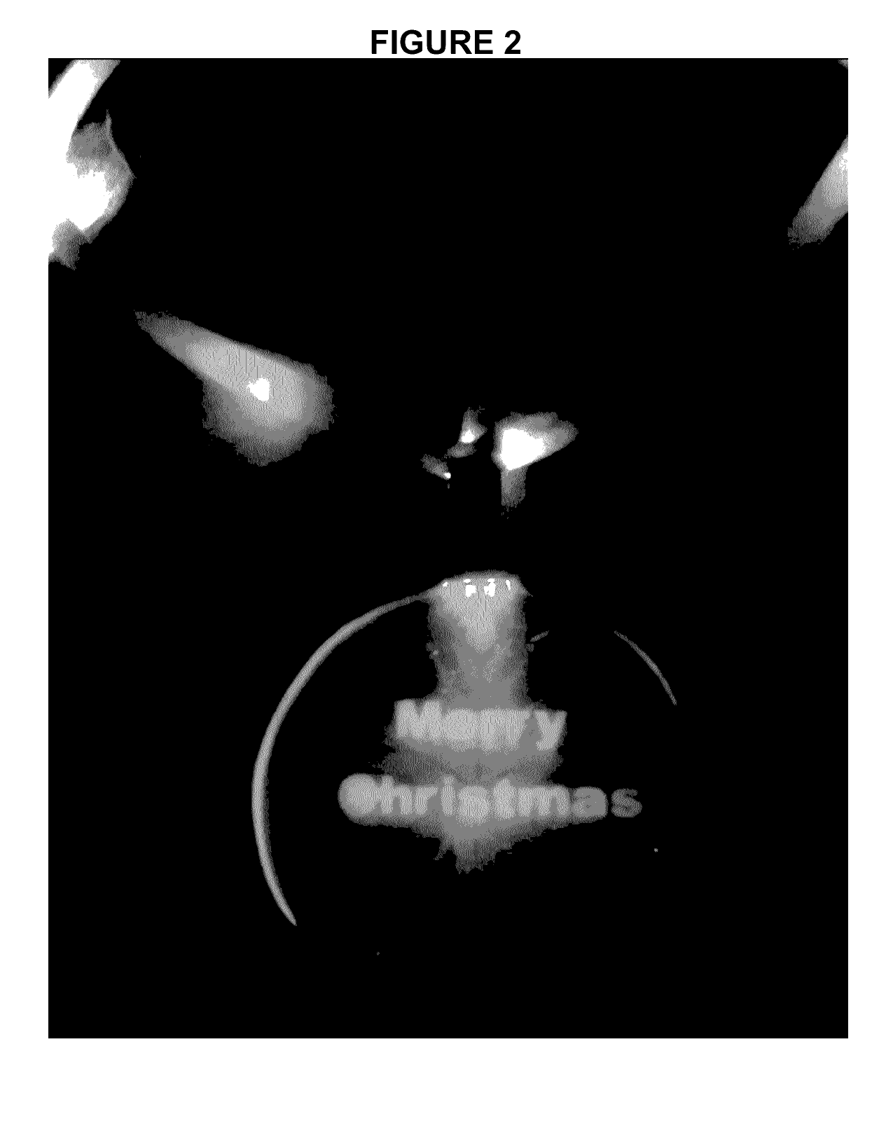

FIG. 2 shows one embodiment of the present invention with an illuminated pendant, which has the text “MERRY CHRISTMAS” etched within said pendant or engraved into said pendant's surface, connected to an illuminated accessory. In this embodiment, the LED attached to the layer of the pendant that has the “MERRY CHRISTMAS” text sandblasted into its surface is illuminated and illuminates the “MERRY CHRISTMAS” text within such layer of the pendant, and the illuminated accessory is a neckpiece.

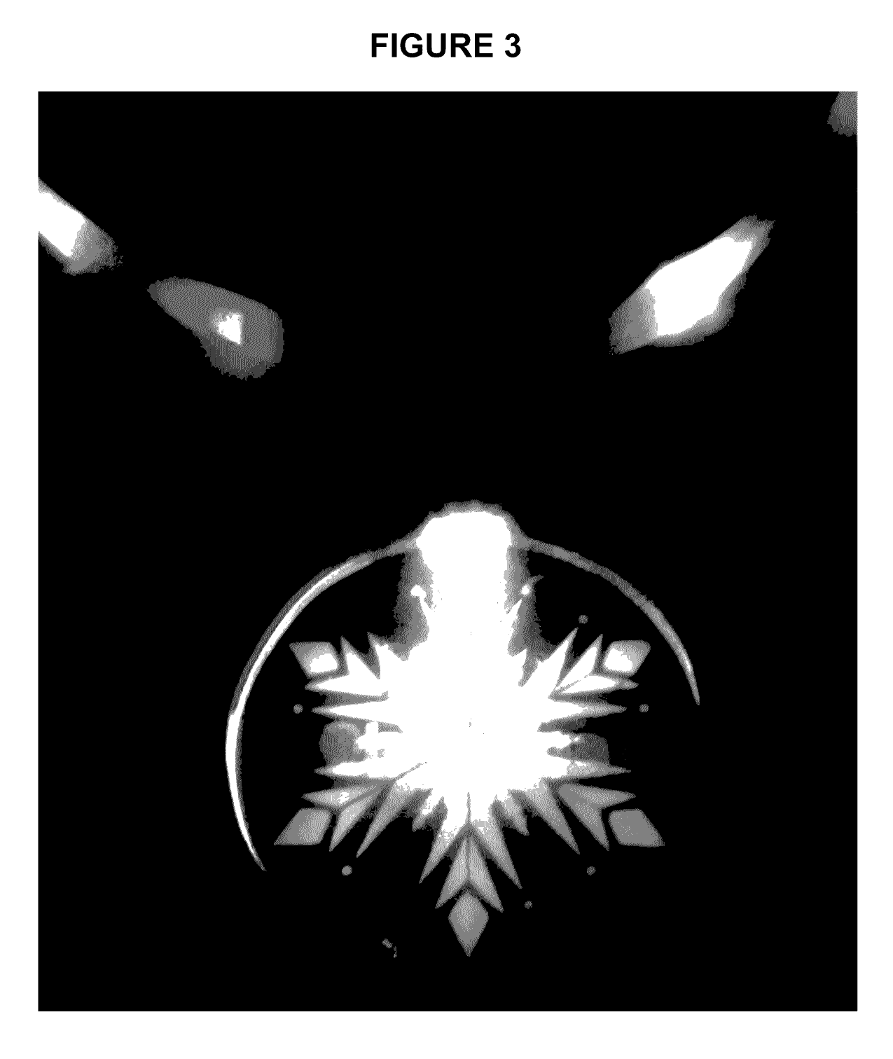

FIG. 3 shows one embodiment of the present invention with an illuminated pendant, which has the text “MERRY CHRISTMAS” and the image of a snowflake etched within said pendant and/or engraved into said pendant's surface, connected to an illuminated accessory, and shows the transition of the LEDs bringing the “MERRY CHRISTMAS” text into focus and bringing the snowflake image out of focus. In this embodiment, the LED attached to the layer of the pendant that has the “MERRY CHRISTMAS” text sandblasted into its surface is beginning to illuminate and illuminates the “MERRY CHRISTMAS” text within such layer of the pendant, while the LED attached to the layer of the pendant that has the image of the snowflake sandblasted into its surface is dimming and dims the image of the snowflake within such layer of the pendant, and the illuminated accessory is a neckpiece. The transition from illuminating and dimming between the sets of LEDs creates an animation of the images and text within the layers of the pendant. Such animation is similar to that of a flipbook where a succession of images showing a sequence of movements is displayed in a manner that creates the illusion of continual movement of the images to the observer.

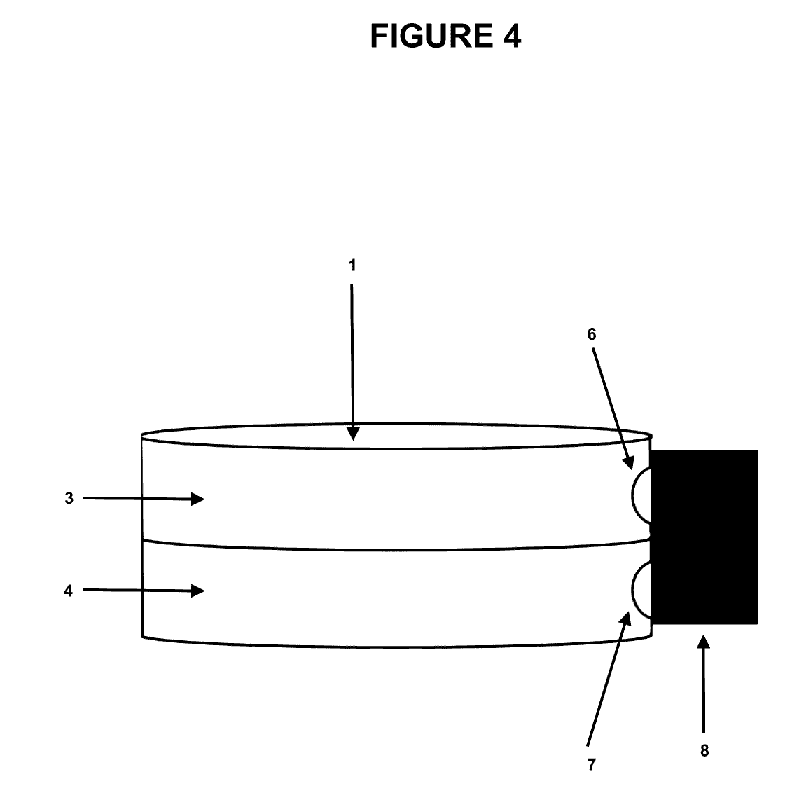

FIG. 4 is a diagram of a side view of one embodiment of the present invention with a front surface 1, a first layer of translucent or transparent material 3, and a second layer of translucent or transparent material 4. The first layer of translucent or transparent material 3 is connected to an LED 6 that is designated to and used solely in connection with the first layer of translucent or transparent material 3. The second layer of translucent or transparent material 4 is connected to an LED 7 that is designated to and used solely in connection with the second layer of translucent or transparent material 4. The LEDs 6, 7 are housed within a housing unit 8.

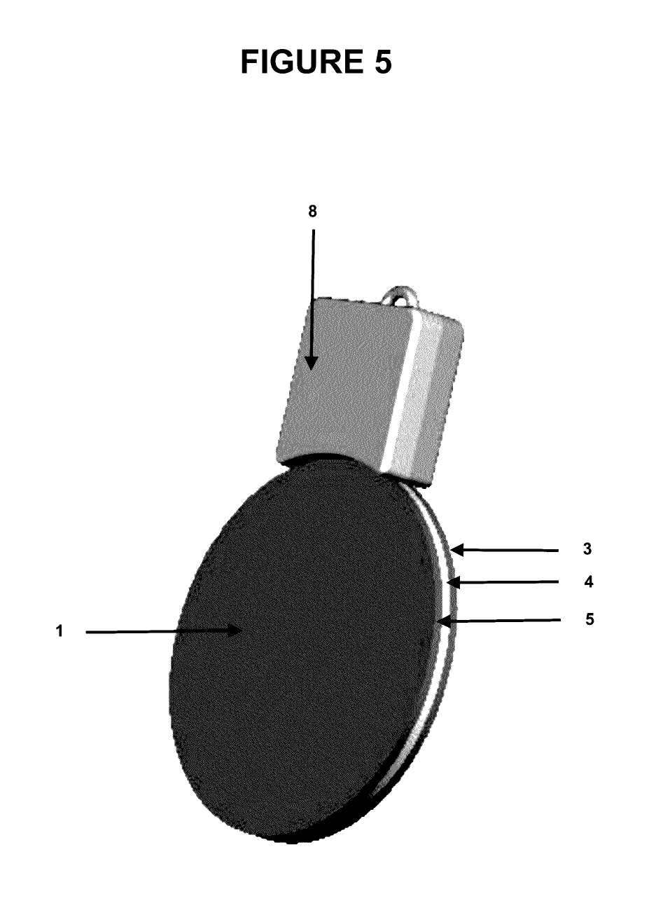

FIG. 5 is a view of the front and side of one embodiment of the present invention with a front surface 1, a first layer of translucent or transparent material 3, a second layer of translucent or transparent material 4, and a third layer of translucent or transparent material 5. The first layer of translucent or transparent material 3 is connected to an LED (not shown) that is located within the housing unit 8 and designated to and used solely in connection with the first layer of translucent or transparent material 3. The second layer of translucent or transparent material 4 is connected to an LED (not shown) that is located within the housing unit 8 and designated to and used solely in connection with the second layer of translucent or transparent material 4. The third layer of translucent or transparent material 5 is connected to an LED (not shown) that is located within the housing unit 8 and designated to and used solely in connection with the third layer of translucent or transparent material 5.

The embodiments of the present invention shown in FIGS. 1-3 may include an electroluminescence assembly in place of or as a supplement to the LED lights shown.

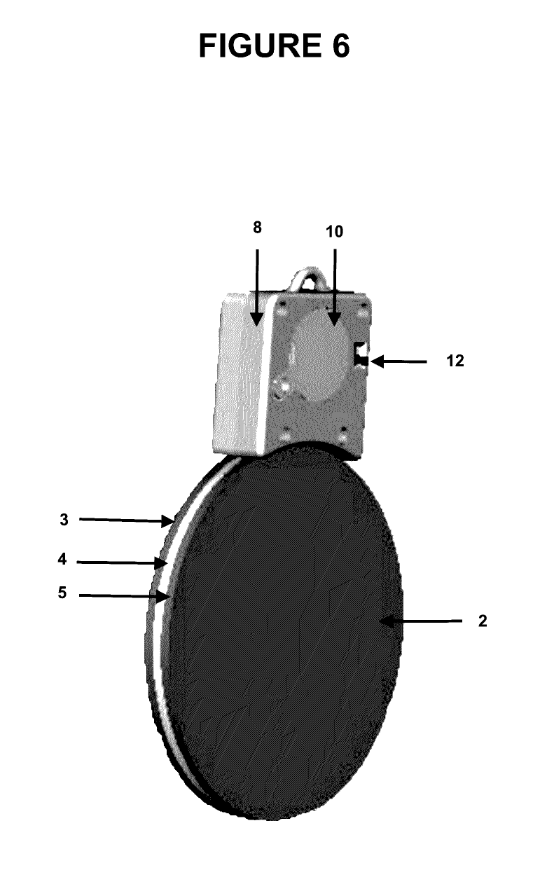

FIG. 6 is a view of the back and side of one embodiment of the present invention with a back surface 2, a first layer of translucent or transparent material 3, a second layer of translucent or transparent material 4, and a third layer of translucent or transparent material 5. A battery compartment door 10 and on/off switch 12 are located on the back of the housing unit 8.

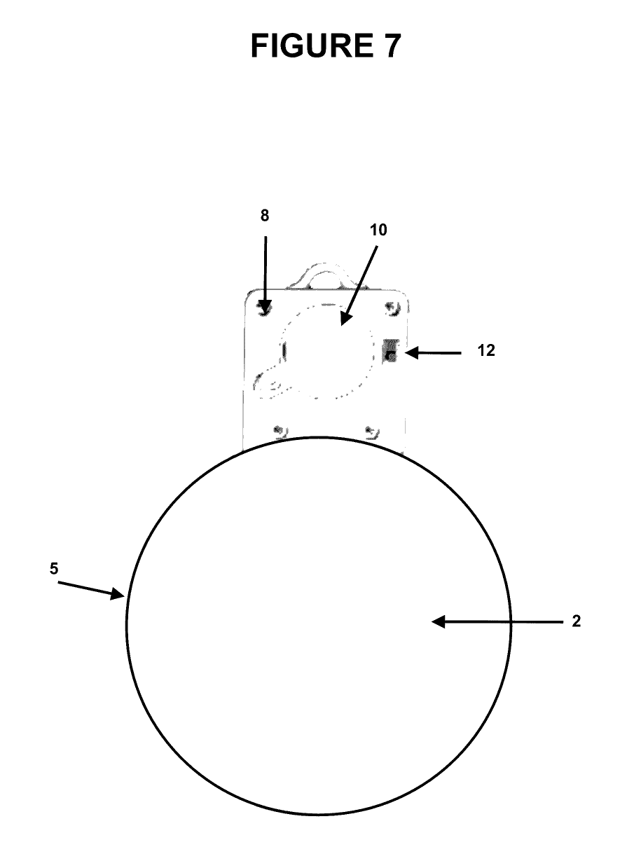

FIG. 7 is a view of the back of one embodiment of the present invention showing a back surface 2, which is part of the third layer of translucent or transparent material 5, and a battery compartment door 10 and on/off switch 12 that are located on the back of the housing unit 8.

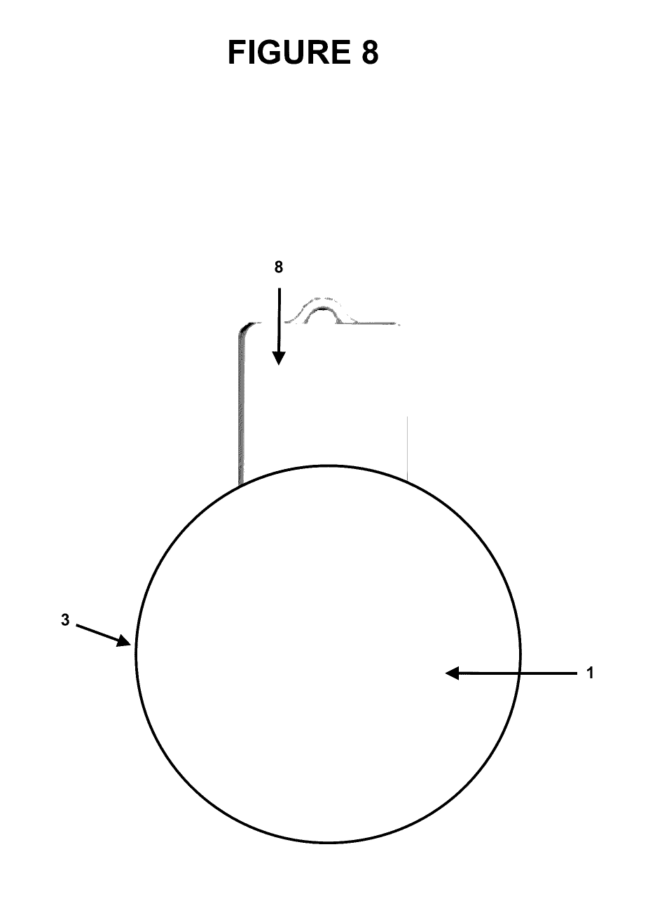

FIG. 8 is a view of the front of one embodiment of the present invention showing a front surface 1, which is part of the first layer of translucent or transparent material 3, and the front of the housing unit 8.

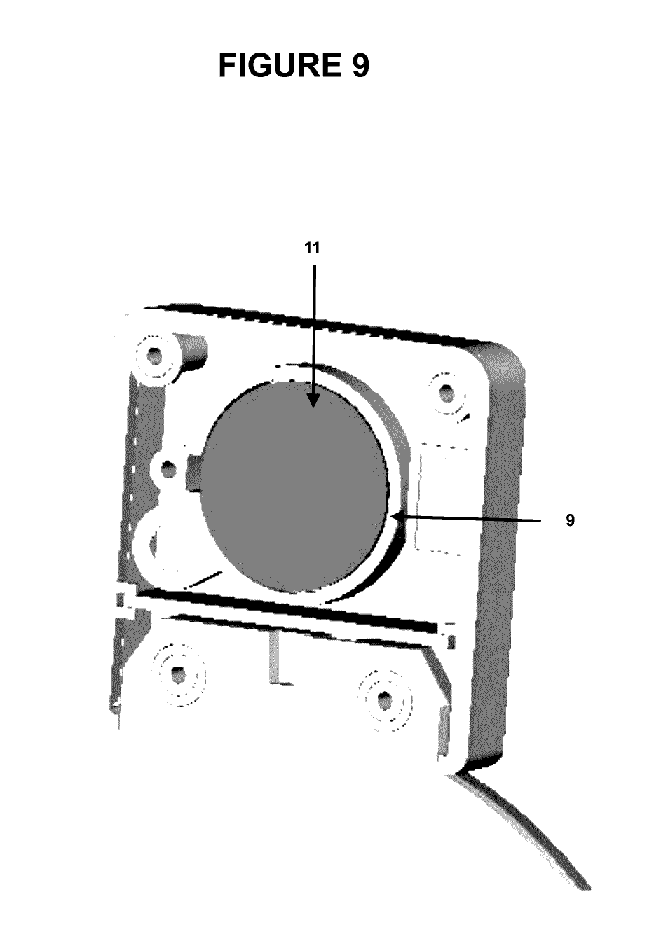

FIG. 9 is a view of inside the housing unit 8 in one embodiment of the present invention. The battery 11 is located within the battery compartment 9.

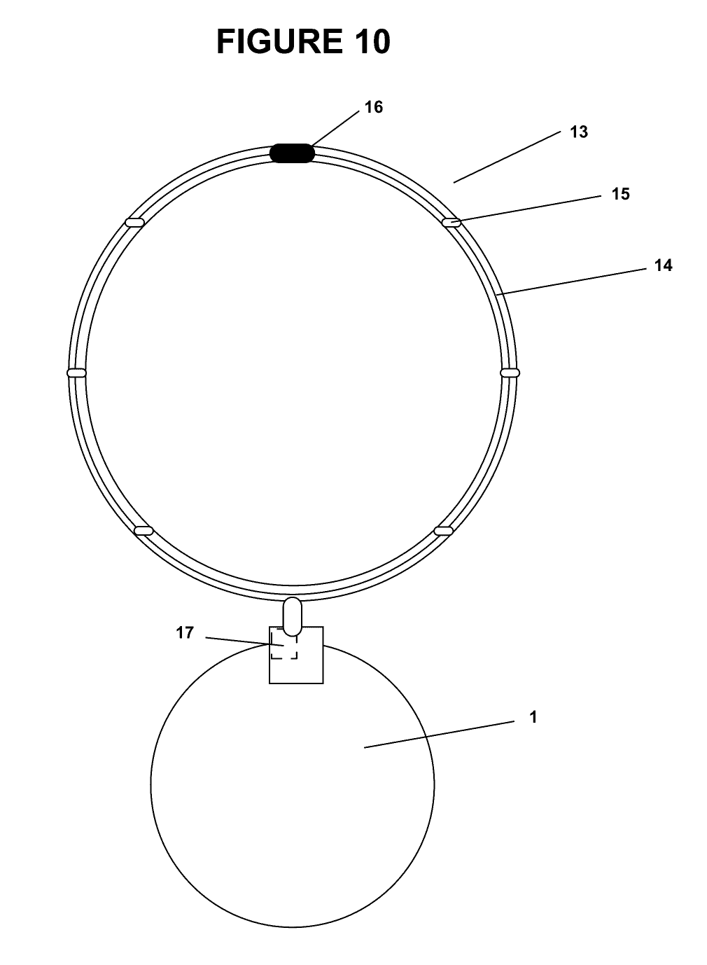

FIG. 10 is a front view of one embodiment of the present invention showing the front surface 1 of the present invention with the invention attached or otherwise connected to an illuminated accessory 13. The illuminated accessory includes a light string system 15 with LEDs 14 and an illuminated accessory power source 16 for such light string system. Other embodiments of the present invention may include an electroluminescence assembly in place of or as a supplement to the light string system 15 shown. Additionally connected to the front surface 1 of the present invention is a tracking apparatus 17.

Although preferred embodiments of the present invention have been described it will be understood by those skilled in the art that the present invention should not be limited to the described preferred embodiments. Rather, various changes and modifications can be made within the spirit and scope of the present invention.

### COMPONENT LIST FOR DRAWINGS

Following is a partial list of the components depicted in the drawings:

| Component Number | Component Description |
|---|---|
| 1 | Front Surface |
| 2 | Back Surface |
| 3 | First Layer of Translucent or Transparent Material |
| 4 | Second Layer of Translucent or Transparent |
| | Material |
| 5 | Third Layer of Translucent or Transparent Material |
| 6 | First LED |
| 7 | Second LED |
| 8 | Housing Unit |
| 9 | Battery Compartment |
| 10 | Battery Compartment Door |
| 11 | Battery |
| 12 | On/Off Switch |
| 13 | Illuminated Accessory |
| 14 | Light String System |
| 15 | LED of Light String System |
| 16 | Illuminated Accessory Power Source |
| 17 | Tracking Apparatus |

### DEFINITIONS

As used herein, the term “and/or,” when used in a list of two or more items, means that any one of the listed items can be employed by itself, or any combination of two or more of the listed items can be employed. For example, if a device is described as containing components A, B, and/or C, the composition can contain A alone; B alone; C alone; A and B in combination; A and C in combination; B and C in combination; or A, B, and C in combination.

A “controlling, executing and/or operating software application” is defined as a program used to control, operate, and/or operate on at least one of the following: a stationary, handheld and/or mobile device, a tablet, smart phone, stationary phone, smart device, computer, hand held device, mobile phone, touch-screen computing device, portable media player, smart pad, smart device, laptop, desktop computer, micro device, portable device, technical device, virtual device, a remote control, a communication transmitter device, a communication transmitter/receiver device, a tracking apparatus, and/or a communication receiver device, among others.

A “remote control” is defined as an electronic device used to wirelessly control another electronic device.

A “stationary, handheld and/or mobile device” is defined as an electronic device that can be at least one of the following: a tablet, smart phone, stationary phone, smart device, computer, hand held device, mobile phone, touch-screen computing device, portable media player, smart pad, smart device, laptop, desktop computer, micro device, portable device, technical device, and/or virtual device.

A “communication receiver device” is defined as any electronic device that can receive signals such as GPS, Wi-Fi, radio wave, Bluetooth, RFID, radio waves, sonar, sonic, audio, and/or infrared.

A “communication transmitter device” is defined as any electronic device that can transmit signals such as GPS, Wi-Fi, radio wave, Bluetooth, RFID, radio waves, sonar, sonic, audio, and/or infrared.

A “communication transmitter/receiver device” is defined as any electronic device that can transmit and/or receive signals such as GPS, Wi-Fi, radio wave, Bluetooth, RFID, radio waves, sonar, sonic, audio, and infrared.

What is claimed:

1. A device comprising of at least one of the following:
at least one light-emitting diode assembly, wherein said at least one light-emitting diode assembly is comprised of at least one of at least one light-emitting diode, and/or at least one resistor;
at least one electroluminescence assembly, wherein said at least one electroluminescence assembly is comprised of at least one of at least one electroluminescent wire, sheet, panel, or tape, and/or at least one inverter;
at least one power source operably connected to at least one of the at least one light-emitting diode assembly or the at least one electroluminescence assembly, wherein at least one of the at least one light-emitting diode assembly and/or said at least one electroluminescence assembly is connected to said at least one power source whereby a circuit is formed;
at least one power source compartment, wherein said at least one power source compartment houses the at least one power source;
at least one transparent and/or translucent material, wherein said at least one transparent and/or translucent material is and/or has at least one of:
capable of transmitting and/or radiating light;
made of at least one of glass, plexiglass, acrylic, and/or resin;
at least one of images, text, logos, slogans, characters, other visual materials, and/or other visual content that are at least one of etched, sandblasted, molded, engraved, imprinted, ingrained, cut, impressed and/or outlined into or on said at least one transparent and/or translucent material;
circuitry associated with and/or used to control at least one of the at least one light-emitting diode assembly, the at least one electroluminescence assembly, and/or the at least one power source, wherein said circuitry, when associated with and/or used to control at least one of the at least one light-emitting diode assembly and/or the at least one electroluminescence assembly, provides at least one of the following light pattern types: random, regular, controlled sequence and/or pattern, custom sequence and/or pattern, and/or sequence and/or pattern incorporating at least one constant timing, variable timing and/or dimming function;
at least one switch or other circuit activating and/or deactivating device; or
at least one housing unit.

2. The device of claim 1 wherein said at least one power source is at least one battery.

3. The device of claim 1 wherein said at least one switch or other circuit activating and/or deactivating device is an on/off switch that activates and/or deactivates the circuitry associated with and/or used to control at least one of the at least one light-emitting diode assembly, the at least one electroluminescence assembly, and/or the at least one power source.

4. The device of claim 1 wherein the at least one light-emitting diode assembly and/or the at least one electroluminescence assembly at least one of:
attaches or otherwise connects to the at least one transparent and/or translucent material; and/or
directs light into and/or through the at least one transparent and/or translucent material.

5. The device of claim 1 wherein the at least one transparent and/or translucent material is at least two transparent and/or translucent materials, the at least one light-emitting diode of the at least one light-emitting diode assembly, if present, is at least two light-emitting diodes, and/or the at least one electroluminescent wire, sheet, panel, or tape of the at least one electroluminescence assembly, if present, is at least two electroluminescent wires, sheets, panels, or tape.

6. The device of claim 5 wherein said at least two transparent and/or translucent materials are connected, combined, or otherwise attached to one another to form a combined piece of transparent and/or translucent material, wherein each of the at least two transparent and/or translucent materials is a separate layer of said combined piece of transparent and/or translucent material.

7. The device of claim 6 wherein each separate layer of the combined piece of transparent and/or translucent material is connected or otherwise attached to at least one of at least one of the at least two light-emitting diodes of the at least one light-emitting diode assembly, and/or at least one of the at least two electroluminescent wires, sheets, panels, or tape of the electroluminescence assembly.

8. The device of claim 7 wherein at least one of at least one of the at least two light-emitting diodes, and/or at least one of the at least two electroluminescent wires, sheets, panels, or tape is used only in connection with a designated separate layer of the combined piece of transparent and/or translucent material, and is not shared or used by any other separate layer of the combined piece of transparent and/or translucent material.

9. The device of claim 8 wherein:
at least one of each of the at least two light-emitting diodes, and/or each of the at least two electroluminescent wires, sheets, panels, or tape provides light into and/or through such light-emitting diode or electroluminescent wire, sheet, panel, or tape's designated separate layer of the combined piece of transparent and/or translucent material in a sequence; and/or
the light from at least one of each of the at least two light-emitting diodes, and/or each of the at least two electroluminescent wires, sheets, panels, or tape is provided in sequence, and not in parallel, and such light sequence creates the appearance of animation of images, text, logos, slogans, characters or other visual materials and content that are at least one of etched, sandblasted, molded, engraved, imprinted, ingrained, cut, impressed and/or outlined into or on such layer of the one piece of transparent and/or translucent material as the sequence progresses.

10. The device of claim 1 wherein the device is attached or removably attachable to an illuminated accessory that operates independently from or in conjunction with said device comprising at least one of the following:
at least one light string system;
at least one internal light string system;
at least one illuminated accessory electroluminescence assembly, wherein said at least one illuminated accessory electroluminescence assembly is comprised of at least one of at least one electroluminescent wire, sheet, panel, or tape, and/or at least one inverter;
at least one illuminated accessory power source, wherein said at at least one illuminated accessory power source comprises at least one of at least one battery, and/or at least one printed circuit board;
at least one pliable material, wherein said at least one pliable material is made of pliable material, such as cloth, fabric, wire, rubber, metal, elastic, spandex, twine, rope, and/or cord; and/or
at least one translucent material, wherein said at least one translucent material is at least one of flexible and/or inflexible.

11. The illuminated accessory of claim 10 wherein said light string system, if present, and/or said internal light string system, if present, is comprised of at least one lighting and/or lamp system tied together with at least one conductive wire, wherein each lighting and/or lamp system consists of at least one of at least one light assembly, at least one bulb assembly, and/or at least one socket assembly.

12. The illuminated accessory of claim 10 wherein at least one of the at least one light string system, the at least one internal light string system, and/or the illuminated accessory electroluminescence assembly is connected to at least one of the at least one light-emitting diode assembly, the at least one electroluminescence assembly, the at least one power source, the circuitry associated with and/or used to control at least one of the at least one light-emitting diode assembly, the at least one electroluminescence assembly, and/or the at least one power source, and/or the at least one illuminated accessory power source.

13. The illuminated accessory of claim 10 wherein the circuitry associated with and/or used to control at least one of the at least one light-emitting diode assembly, the at least one electroluminescence assembly, and/or the at least one power source of the device additionally controls at least one of the at least one light string system, the at least one internal light string system, and/or the at least one electroluminescent panel, and causes at least one of the following light pattern types: random, regular, controlled sequence and/or pattern, custom sequence and/or pattern, sequence and/or pattern incorporating at least one constant timing, variable timing and/or dimming function.

14. The illuminated accessory of claim 10 wherein the at least one light string system and/or at least one internal light string system, if present, having at least two LEDs directly connected to the same circuitry and/or wiring in a sequential manner without the need or use of any light string covers.

15. The device of claim 1 further comprising a tracking and/or communication system comprising at least one of the following:
a tracking apparatus;
a communication receiver device;
at least one of a control device and/or a communication transmitter device and/or a communication transmitter/receiver device;
at least one power source, wherein said at least power source is comprised of at least one of: at least one battery, at least one battery compartment, and/or at least one battery compartment door;
a controlling, executing and/or operating software application utilized to control or operate at least one control device and/or communication transmitter device and/or communication receiver device and/or communication transmitter/receiver device;
at least one LED light;
at least one switch and/or at least one sensor and/or at least one connector;
circuitry to control at least one LED light; and/or
a transparent and/or translucent flexible exterior material permitting the transmission of light.

16. The tracking and/or communication system of claim 15 wherein at least one of the at least one tracking apparatus, and/or at least one control device, and/or at least one communication receiver device, and/or the at least one communication transmitter device, and/or the at least one communication transmitter/receiver device, if present, can receive and/or transmit at least one of the following signals: GPS, Wi-Fi, radio wave, Bluetooth, RFID, radio waves, sonar, sonic, audio, vibration, light, sound, and/or infrared.

17. The tracking and/or communication system of claim 15 wherein at least one communication receiver device and/or at least one communication transmitter device and/or at least one communication transmitter/receiver device, if present, is attached or connected to, and/or located partially or wholly within or inside the tracking apparatus and/or is the tracking apparatus.

18. The tracking and/or communication system of claim 15 wherein at least one communication receiver device and/or at least one communication transmitter device and/or at least one communication transmitter/receiver device is located within or is attached to at least one control device.

19. The tracking and/or communication system of claim 15 wherein the at least one control device is at least one of at least one remote control, computer, input device, output device, tablet, smart phone, smart device, sound device, public address (PA) system, audio system, amplifier system, speakers, and/or a stationary, handheld, and/or mobile device.

20. The tracking and/or communication system of claim 19 wherein the at least one remote control, if present, further comprises at least one button or other signal controller that, when depressed or initiated or activated, sends or receives at least one signal from or to the at least one communication transmitter device or communication transmitter/receiver device located in the at least one remote control to the at least one communication receiver device or communication transmitter/receiver device located in the at least one tracking apparatus.

21. The tracking and/or communication system of claim 15 wherein the at least one controlling, executing and/or operating software application, when activated and/or instructed to, sends a signal from the at least one communication transmitter device or communication transmitter/receiver device located in the control device to the tracking apparatus and/or at least one communication receiver device and/or communication transmitter/receiver device located in/on the at least one tracking apparatus.

22. The tracking and/or communication system of claim 15 wherein the at least one tracking apparatus can be placed, embedded within, or built inside said at least one housing unit of the device with lighting, location, and communication systems, or removably attached via an attaching mechanism to said at least one housing unit.

23. The tracking and/or communication system of claim 15 wherein at least one of the following:
the at least one tracking apparatus is attached or otherwise connected to the at least one switch or other circuit activating and/or deactivating device and/or the circuitry associated with and/or used to control the at least one light-emitting diode assembly, the at least one electroluminescence assembly, and/or the at least one power source whereby at least one tracking apparatus and/or control device to control the patterns of lighting produced by said light-emitting diode assembly and/or the light string system and/or internal light string system; and/or
the at least one tracking apparatus and/or control device further comprises at least one of the following: a speaker, an audio or sound device, and/or a vibrating device.

24. The tracking and/or communication system of claim 15 wherein the at least one control device can send at least one signal from the at least one communication transmitter device or communication transmitter/receiver device located in the control device to the at least one communication receiver device or communication transmitter/receiver device located in/on the tracking apparatus that results in the at least one speaker and/or audio device, if present, emitting a sound, the at least one light-emitting diode assembly and/or the electroluminescence assembly, if present, illuminating, the vibrating device, if present, vibrating, and/or the at least one communication receiver device or communication transmitter/receiver device transmitting and/or sending at least one signal to the at least one communication transmitter device or communication transmitter/receiver device.

25. The device of claim 15 whereby at least one of the following:
said at least one switch and/or at least one sensor and/or at least one connector can be sensed by and/or connected to electronics;
said at least one switch and/or at least one sensor can be at least one of motion and/or acceleration and/or impact activated;
motion and/or said at least one sensor output can cause electronics to remain active for a minimum period of time;
if motion and/or said at least one sensor output has not caused activation for said minimum period of time, the electronics enters a low current sleep mode to conserve battery energy;
motion and/or said at least one sensor output can initiate wake up of electronics from a low current mode;
the at least one sensor can sense acoustic energy and/or audio from the environment and convert said acoustic energy and/or audio into a signal;
the device further comprises electronics able to control the lighting of said at least one LED light in at least one lighting sequence; and/or
said at least one switch and/or at least one sensor activation can initiate at least one lighting sequence.

26. The device of claim 25 whereby at least one of the following:
the at least one lighting sequence is at least one of the following: repetitive, and/or random;
the at least one lighting sequence can incorporate at least one of the following: constant timing, variable timing, and/or a dimming function;
said signal can be resolved into frequency and/or amplitude and/or a combination thereof; and/or
said at least one connector is a connector and/or jack for connecting to an audio, video and/or other content source and/or power.

27. The device of claim 25 whereby said frequency and/or amplitude and/or a combination thereof can control or affect the pattern and or intensity of LED lighting.

28. The device of claim 1 wherein the device can be at least one of the following: worn by a user, attached to other objects, held in a user's hand, put on display, or formed in any shape, including the shape of glasses, a toy star, toy planet, crystal, sphere, rod, staff, blade, disk, device, wand, multi-sided, polyhedron shape, geometric shape, triangle shape, quadrilateral shape, pentagon shape, hexagon shaped, septagon shaped, octagon shaped, polygon of any number of sides, a commonly recognizable toy(s), consumer product, and/or shape(s) including but not limited to: a character, caricature, celebrity or person's shape or image in whole or part, logo, symbol, rocket, airplane, car, animal, bug, plant, rock, rock formation, body part(s), machine, vehicle, boat, alien, wand, sword, knife, gun, pistol, boat, submarine, toy sword, toy vehicle, toy gun, toy, toy shield, toy wand, doll, toy figure, figurine, toy figurine, action figure, toy action figure, remote controlled vehicle, remote controlled airplane, remote control toy, remote controlled helicopter, remote controlled rocket, and/or remote controlled quad copter, hand held toy(s), construction toy(s), toy block(s), pet(s), accessories, apparel, footwear, hair accessories, jewelry, fashion accessories, sports balls and equipment, bike accessories, bike spokes, costumes, headwear, skateboard accessories, wheels, wheel accessories, vehicle accessories, skateboard wheels, snowboard, yo-yo, spinning top, fan, Frisbee, nightstand, nightlight, electronic device, radio, clock radio, mobile phone accessory, and/or desktop device.

29. The illuminated accessory of claim 10 wherein the illuminated accessory can be at least one of the following: worn by a user, attached and/or connected to other objects, held in a user's hand, put on display, or formed in any shape, including the shape of glasses, a toy star, toy planet, crystal, sphere, rod, staff, blade, disk, device, wand, multi-sided, polyhedron shape, geometric shape, triangle shape, quadrilateral shape, pentagon shape, hexagon shaped, septagon shaped, octagon shaped, polygon of any number of sides, a commonly recognizable toy(s), consumer product, and/or shape(s) including but not limited to: a character, caricature, celebrity or person's shape or image in whole or part, logo, symbol, rocket, airplane, car, animal, bug, plant, rock, rock formation, body part(s), machine, vehicle, boat, alien, wand, sword, knife, gun, pistol, boat, submarine, toy sword, toy vehicle, toy gun, toy, toy shield, toy wand, doll, toy figure, figurine, toy figurine, action figure, toy action figure, remote controlled vehicle, remote controlled airplane, remote control toy, remote controlled helicopter, remote controlled rocket, and/or remote controlled quad copter, hand held toy(s), construction toy(s), toy block(s), pet(s), accessories, apparel, footwear, hair accessories, jewelry, fashion accessories, sports balls and equipment, bike accessories, bike spokes, costumes, headwear, skateboard accessories, wheels, wheel accessories, vehicle accessories, skateboard wheels, snowboard, yo-yo, spinning top, fan, Frisbee, nightstand, nightlight, electronic device, radio, clock radio, mobile phone accessory, and/or desktop device.
